(19) United States
(12) Patent Application Publication
(10) Pub. No.: US 2010/0135008 A1
(43) Pub. Date: Jun. 3, 2010

(54) LED STREETLIGHT WITH HEAT-DISSIPATING STRUCTURE

(76) Inventor: Richard TENG, Dashe Township (TW)

Correspondence Address: SINORICA, LLC, 2275 Research Blvd., Suite 500, ROCKVILLE, MD, 20850, US

(21) Appl. No.: 12/326,393

(22) Filed: Dec. 2, 2008

(51) Int. Cl. F21S 8/00

(52) U.S. Cl. 362/227

(57) ABSTRACT

An LED streetlight with heat-dissipating structure. The LED streetlight includes a light housing composed of an upper cover and a lower cover connected therewith to define an opening, a common rail assembly fixedly attached to an inner face of a bottom of the light housing, and a gas-permeable shade. The common rail assembly includes multiple common rail base seats connected with multiple LED light bulbs and multiple circuit boards. The gas-permeable shade is fitted with the end of the light housing to seal the opening thereof. The heat generated by the LED light bulbs are conducted by the common rail base seats and dissipated to internal space and outer side of the light housing. The heat on outer side of the light housing is carried away by external cold air. The heat in the internal space of the light housing is quickly dissipated through the gas-permeable shade to outer side of the light housing by way of thermal convection.

### FIELD OF THE INVENTION

The present invention relates to an LED streetlight with heat-dissipating structure.

### BACKGROUND OF THE INVENTION

LED light has the advantages of low power consumption, high brightness, long using life, etc. An LED streetlight can be used instead of a conventional mercury streetlight to eliminate the problems existing therein. However, LED light has poorer heat resistance. The heat generated by the LED light is likely to cause overheating of circuit board and damage of the light. Therefore, a radiating module is often used to help in conducting and dissipating the heat generated by the LED light. With the radiating module, the LED light can emit light at lower temperature so as to prolong using life.

Currently, a cooling fan is generally used to dissipate the heat generated by LED illuminator and lower the temperature by way of forced convection. Alternatively, a material with high thermal conductivity is used to conduct and dissipate the heat. In the case that a cooling fan is used to forcedly dissipate the heat, the LED light must be formed with ventilation holes in cooperation with the cooling fan to quickly dissipate the heat. It is known that a streetlight is long-term exposed to outdoor environment. Therefore, the streetlight is required to have higher sealability, waterproofness, dustproofness and heat dissipation capability than an indoor illuminator. Accordingly, the above means for conducting heat and dissipating heat by way of forced convection are inapplicable to the outdoor illuminator (streetlight).

### SUMMARY OF THE INVENTION

It is therefore a primary object of the present invention to provide an LED streetlight, which is able to quickly dissipate heat generated by LED light bulbs at high heat dissipation efficiency and lower the temperature of the LED streetlight. Therefore, the using life of the LED streetlight can be prolonged.

It is a further object of the present invention to provide the above LED streetlight in which the brightness of the LED light bulbs can be adjusted and the LED light bulbs can regularly emit light to provide illuminating effect.

It is still a further object of the present invention to provide the above LED streetlight in which the lighting angle of the LED light bulbs is enlarged to provide higher brightness and better illumination effect.

The present invention can be best understood through the following description and accompanying drawings wherein:

### BRIEF DESCRIPTION OF THE DRAWINGS

FIG. 1 is a perspective exploded view of a preferred embodiment of the present invention;

FIG. 2 is a bottom perspective partially sectional view of the common rail base seat of the preferred embodiment of the present invention;

FIG. 3 is a block circuit diagram of the preferred embodiment of the present invention;

FIG. 4 is a bottom perspective view of the common rail base seat of the present invention;

FIG. 5 is a perspective view of the light housing of the present invention, showing that the gas-permeable shade is to be assembled with the light housing;

FIG. 6 is a perspective view according to FIG. 5, in which the gas-permeable shade is assembled with the light housing of the present invention;

FIG. 7 is a sectional view showing heat transfer of the common rail base seat of the present invention;

FIG. 8 is a sectional view showing heat dissipation of the common rail base seat of the present invention; and

FIG. 9 is a sectional view showing heat dissipation of the light housing of the present invention.

### DETAILED DESCRIPTION OF THE PREFERRED EMBODIMENTS

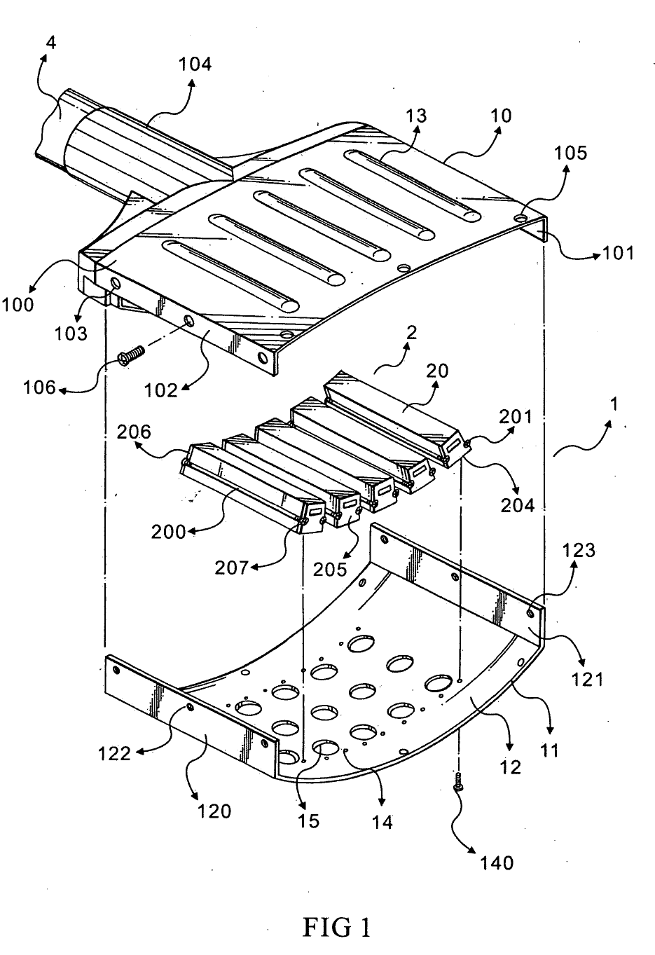

Please refer to FIG. 1. According to a preferred embodiment, the LED streetlight with heat-dissipating structure of the present invention includes a light housing 1, a common rail assembly 2 and a gas-permeable shade 3.

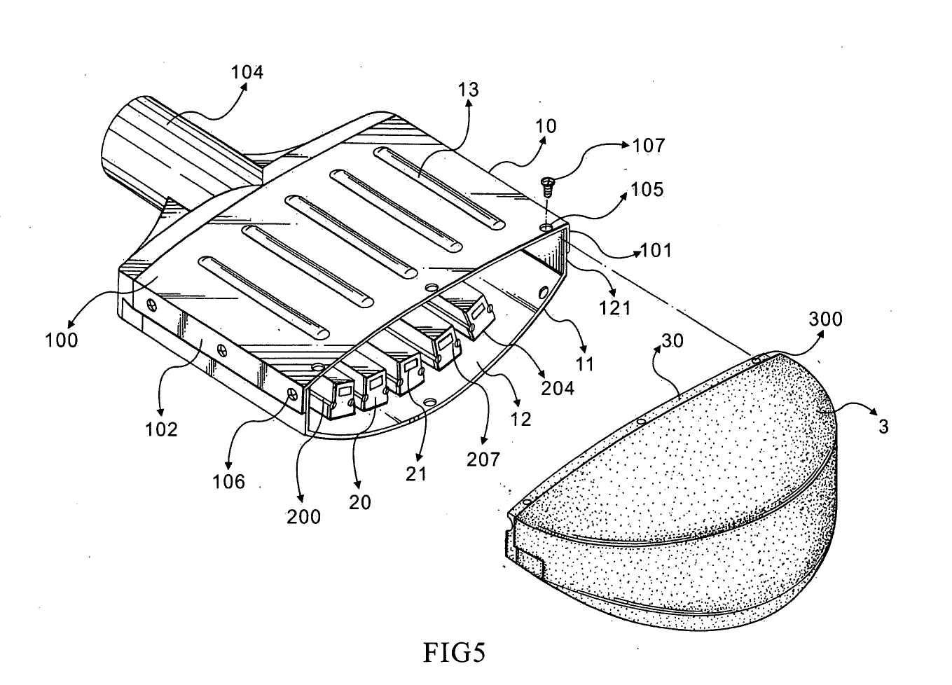

The light housing 1 includes an upper cover 10 and a lower cover 11, which are made of aluminum alloy material. A fixing sleeve 104 is fixedly connected with a rear end of the upper cover 10 and rearward extends from the rear end of the upper cover 10. The LED streetlight can be fixedly connected with a light pole 4 via the fixing sleeve 104. The upper cover 10 has an arced top face 100. In addition, the upper cover 10 is conventionally processed, such as punched, to form several straight reinforcing ribs 13 on the top face 100 of the upper cover 10 for increasing strength thereof. Two assembling walls 101, 102 respectively downward extend from two sides of the top face 100 of the upper cover to define an opening. Several fixing holes 105 are formed on a front edge of the top face 100 of the upper cover 10 above the opening for correspondingly connecting with the gas-permeable shade 3 (as shown in FIG. 5). The assembling walls 101, 102 are formed with several through holes 103. Screws 106 can be passed through the through holes 103 to connect the upper cover 10 with the lower cover 11.

The lower cover 11 has an arced board 12 as the upper cover 10. Two fixing panels 120, 121 respectively upward extend from two sides of the arced board 12 to define an opening of the lower cover 11. The fixing panels 120, 121 are formed with thread holes 122, 123. The number of the thread holes 122, 123 is equal to that of the through holes 103 of the assembling walls 101, 102 of the upper cover 10. More than one through hole 15 is formed on the arced board 12. Preferably, the through holes 15 are arranged in an array of three rows and five columns. Two thread holes 14 are formed near each end of each column. Screws 140 can be screwed through the thread holes 14 from lower side of the lower cover 11 to directly fixedly attach the common rail assembly 2 to an inner face of the arced board 12 of the lower cover 11. The LED light bulbs 230 combined with the common rail assembly 2 outward protrude from the arced board 12 through the through holes 15. The LED light bulbs 230 are fixed at different angles to emit light.

The light housing 1 (as shown in FIG. 1) is assembled in such a manner that the downward extending assembling walls 101, 102 of the upper cover 10 are overlapped with the upward extending fixing panels 120, 121 of the lower cover 11. Then the thread holes 122, 123 of the fixing panels 120, 121 are aligned with the through holes 103 of the assembling walls 101, 102 of the upper cover 10. Then screws 106 are passed through the through holes 103 and screwed through the thread holes 122, 123 to fix the fixing panels 120, 121 with the assembling walls 101, 102 to form a hollow housing. The common rail assembly 2 is directly attached to the inner face of the bottom of the housing (as shown in FIGS. 5, 7 and 8), which serves to absorb and conduct heat generated by the LED light bulbs.

The common rail assembly 2 includes multiple common rail base seats 20, multiple LED light bulb base seats 23, multiple light-transparent base seats 24 and multiple circuit boards 5 connected in the common rail base seats 20. The number of the light-transparent base seats 24 is equal to that of the LED light bulb base seats 23.

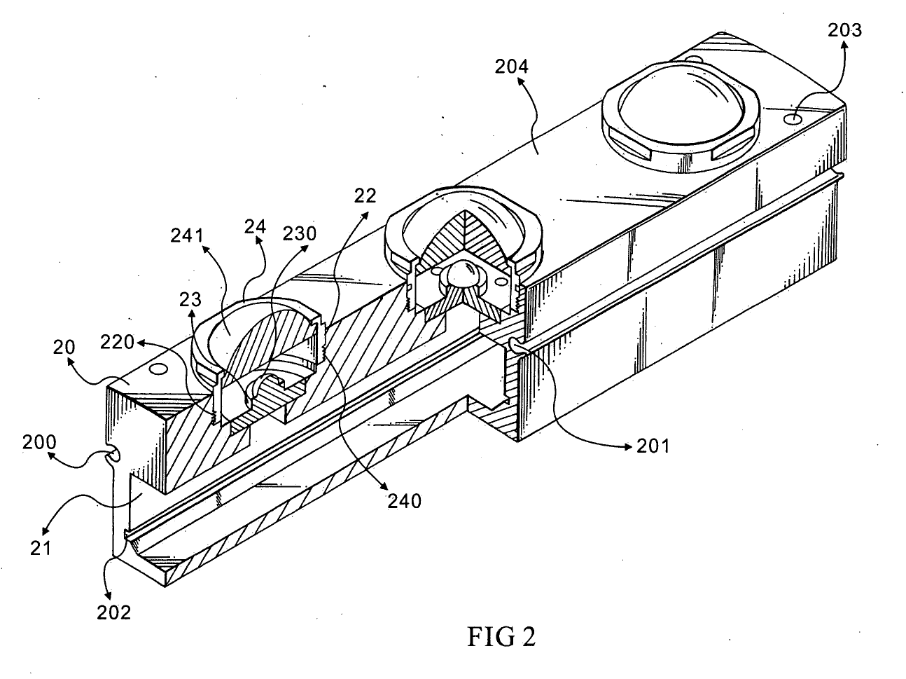

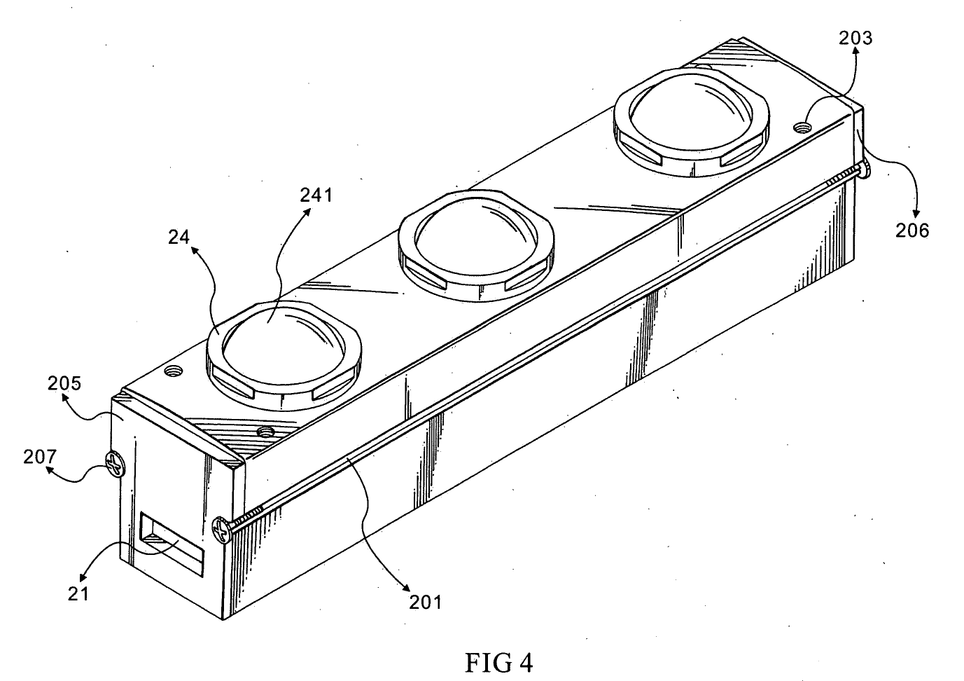

Each common rail base seat 20 (as shown in FIGS. 2 and 4) is an elongated bar body. Two lateral sides of the common rail base seat 20 are stepped to form an upper narrower section and a lower wider section. Two shoulder sections are formed between the upper narrower section and the lower wider section. Two transverse threaded channels 200, 201 are respectively formed on the shoulder sections. The upper narrower section is formed a heat-insulating space 21 longitudinally passing through the common rail base seat 20. An insertion groove 202 is transversely formed on a wall of the heat-insulating space 21. The lower wider section serves as a bottom structure of the common rail base seat 20. Thread holes 203 are formed on a bottom face 204 of the common rail base seat 20 corresponding to the thread holes 14 of the lower cover 11. The bottom face 204 can be attached to the inner face of the lower cover 11 and screws can be screwed through the thread holes 14 of the lower cover 11 into the thread holes 203 to fixedly rest the common rail base seat 20 on the inner face of the lower cover 11. In addition, stepped holes 22 are formed on the bottom face 204 to communicate with the heat-insulating space 21. An LED light bulb base seat 23 is accommodated in the small-diameter section of each stepped hole 22.

The LED light bulb base seat 23 (as shown in FIG. 2) includes a base seat main body 231 and an LED light bulb 230. The base seat main body 231 has a large-area heating face 232 on lower side. The heating face 232 directly attaches to a wall of the small-diameter section of the stepped hole 22 of the common rail base seat 20. Each LED light bulb base seat has two contact pins, which extend from upper end of the LED light bulb base seat to electrically connect with the circuit board 5 (not shown in FIG. 2) transversely inserted in the insertion groove 202 of the heat-insulating space 21. A thread 220 is formed on a wall of a large-diameter section of the stepped hole 22. The light-transparent base seat 24 has a connecting end formed with a thread 240. The connecting end is directly screwed into the stepped hole 22 with the threads 240, 220 screwed together to block the stepped hole 22. A light-transparent shade 241 is connected in the light-transparent base seat 24 for reflecting the light emitted by the LED light bulb to provide illuminating effect.

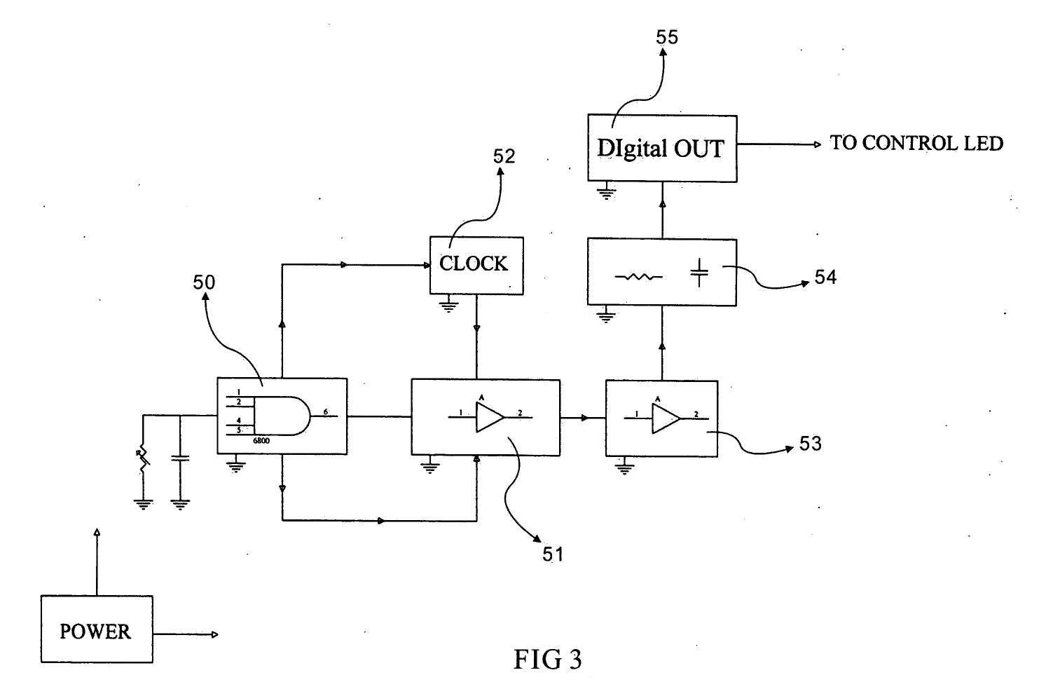

The circuit board 5 (as shown in FIG. 3) is accommodated in the heat-insulating space 21 of the common rail base seat 20 and inserted in the insertion groove 202. The circuit board 5 mainly includes a pulse-width modulation circuit 50, a pre-amplifier circuit 51, a clock generator 52, a clock amplifier high/low pass circuit 53, a timer control circuit 54 and a clock output circuit 55. The pulse-width modulation circuit 50 serves to control and modulate brightness of the LED light bulb 230 in accordance with environmental requirements. The timer control circuit 54 serves to set and control illumination time. By means of the clock generator 52 and the clock amplifier high/low pass circuit 53, the LED streetlight can provide illuminating effect in an automatic regular illumination mode or a manual regular illumination mode.

FIG. 4 shows a preferred embodiment of the present invention. In this embodiment, the LED light bulb base seats 23 are first connected in the common rail base seat 20. Then the light-transparent shades 241 of the light-transparent base seats 24 are connected with the common rail base seat 20 to cover and protect the LED light bulbs 230. The circuit boards 5 are inserted in the insertion grooves 202 of the common rail base seat 20. Screws 207 are screwed into the threaded channels 200, 201 to fix two sealing caps 205, 206 at two ends of the common rail base seat 20 for sealing the ends thereof.

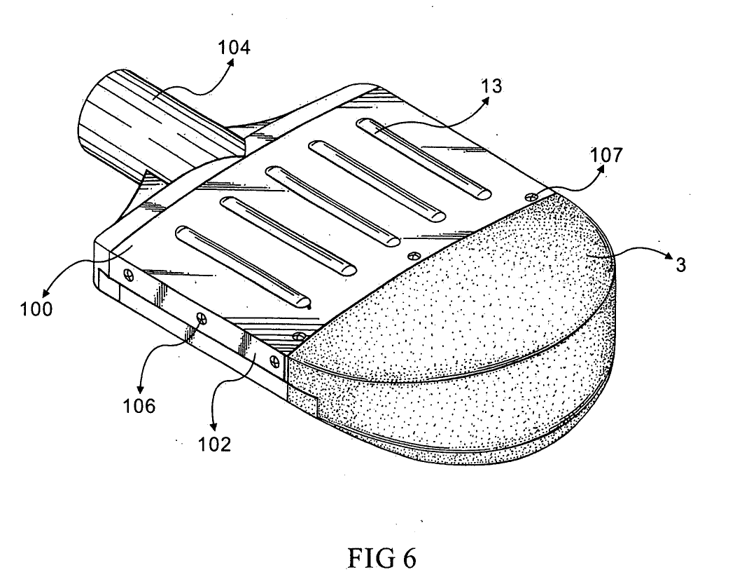

After the light housing 1 and the common rail assembly 2 are assembled, the gas-permeable shade 3 is directly fitted on one end of the light housing 1 to seal the opening thereof (as shown in FIG. 5). The gas-permeable shade 3 is made of gas-permeable material (such as heat-resistant plastic material). A hub section 30 extends from a periphery of an open end of the gas-permeable shade 3. The hub section 30 is formed with several thread holes 300. The hub section 30 can be fitted into the opening of the light housing 1. By means of screws 107, the hub section 30 is fixed between inner faces of the upper and lower covers 10, 11 to block the opening of the light housing 1 and form a complete light body (as shown in FIG. 6). The light body is fixedly connected with the light pole 4 via the fixing sleeve 104 to form a streetlight with a specific inclination. The gas-permeable shade 3 is positioned at top end of the streetlight.

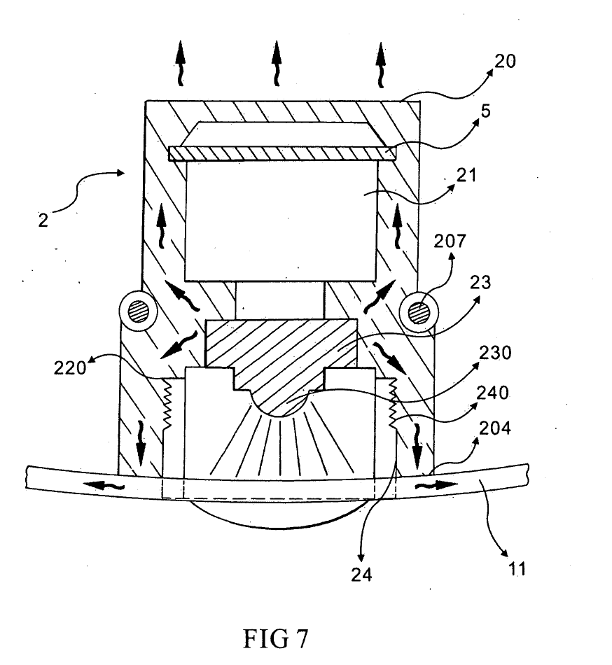

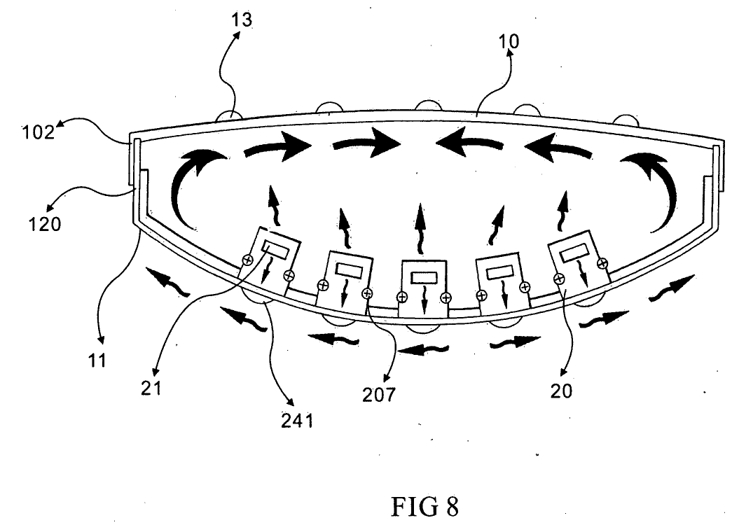

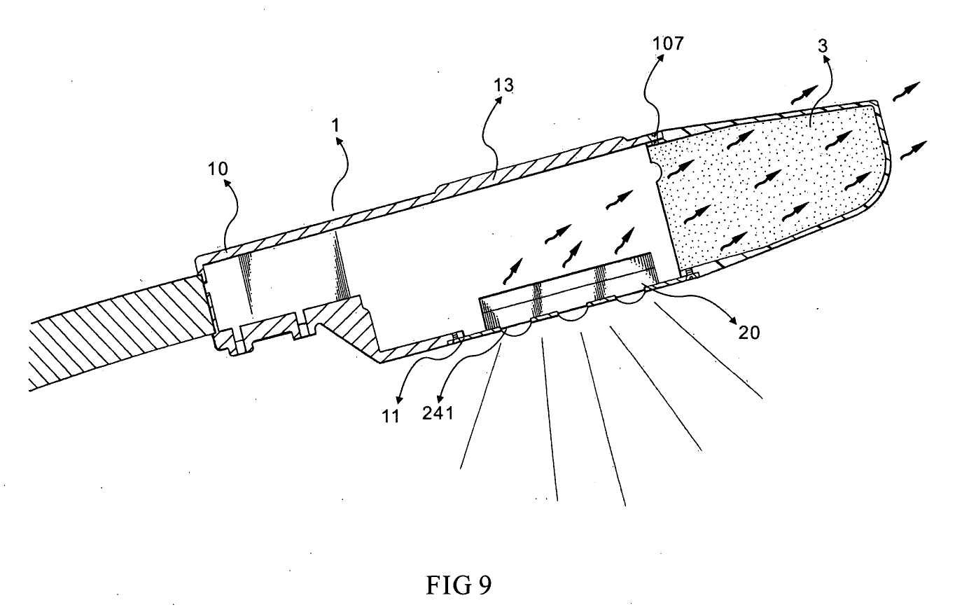

When the streetlight is turned on, the LED light bulbs 230 are powered on to emit light and provide illuminating effect. At this time, high heat is also generated by the LED light bulbs 230. The large-area heating face of the LED light bulb base seat 23 will collect the heat. As aforesaid, the heating face attaches to the wall of the small-diameter section of the stepped hole 22 of the common rail base seat 20. Therefore, the heat is transferred from the heating face to the aluminum alloy-made common rail base seat 20 (as shown in FIGS. 7, 8 and 9). The common rail base seat 20 has high thermal conductivity and attaches to the lower cover 11. Therefore, the heat can be transferred to the light housing 1. Moreover, by means of convention, the heat can be dissipated to internal space and outer side of the light housing 1 (as shown in FIG. 8). The cold air flowing around the light housing 1 will carry away the heat from outer side of the light housing 1. On the other hand, the gas-permeable shade 3 has gas permeability and serves as a thermal convection port. Therefore, the heat accumulating in the internal space of the light housing 1 can be quickly dissipated through the gas-permeable shade 3 to outer side of the light housing by way of thermal convection (as shown in FIG. 9). Accordingly, the LED light bulbs in the light housing can emit light at a lower temperature under protection.

The above embodiments are only used to illustrate the present invention, not intended to limit the scope thereof. Many modifications of the above embodiments can be made without departing from the spirit of the present invention.

What is claimed is:

1. An LED streetlight with heat-dissipating structure, the LED streetlight comprising a light housing, a common rail assembly and a gas-permeable shade, wherein:
the light housing is a hollow body including an upper cover and a lower cover connected therewith, the upper and lower covers defining an opening at one end of the light housing, the lower cover being formed with several through holes;
the common rail assembly is fixedly connected to an inner face of a bottom of the light housing, the common rail assembly including several common rail base seats, several LED light bulb base seats each having an LED light bulb, and several circuit boards, several holes being formed on a bottom face of each common rail base seat, the common rail base seat being formed with an internal heat-insulating space communicating with the holes, the LED light bulb base seats being respectively accommodated in the holes of the common rail base seat, the circuit boards being respectively disposed in the heat-insulating spaces of the common rail base seats and electrically connected with the LED light bulb base seats, bottom ends of the LED light bulb base seats being respectively aligned with the through holes of the lower cover; and
the gas-permeable shade is made of gas-permeable material and fitted with the end of the light housing to seal the opening thereof.

2. The LED streetlight with heat-dissipating structure as claimed in claim 1, wherein the lower cover has arced inner and outer faces in cross-section.

3. The LED streetlight with heat-dissipating structure as claimed in claim 1, wherein the common rail base seat has an upper section and a lower section with different widths in cross-section.

4. The LED streetlight with heat-dissipating structure as claimed in claim 1, wherein each LED light bulb base seat has a large-area bottom face as a heating face attached to and connected with the common rail base seat.

5. The LED streetlight with heat-dissipating structure as claimed in claim 1, wherein the common rail base seats are snugly attached to and connected with the arced inner face of the lower cover for fully transferring heat.

6. The LED streetlight with heat-dissipating structure as claimed in claim 1, wherein each circuit board mainly includes a pulse-width modulation circuit, a pre-amplifier circuit, a clock generator, a clock amplifier high/low pass circuit, a timer control circuit and a clock output circuit.
